(19) United States
(12) Patent Application Publication
(10) Pub. No.: US 2024/0232771 A1
(43) Pub. Date: Jul. 11, 2024

(54) WATER-POLLUTION ENVIRONMENTAL-PROTECTION VERIFICATION METHOD AND APPARATUS BASED ON POWER GRID AND TAX DATA FUSION

(71) Applicant: CHINESE RESEARCH ACADEMY OF ENVIRONMENTAL SCIENCES, Beijing (CN)

(72) Inventors: Haisheng LI, Beijing (CN); Hua JIANG, Beijing (CN); Jianglong CUI, Beijing (CN); Lieyu ZHANG, Beijing (CN); Guowen LI, Beijing (CN); Cao LIU, Beijing (CN); Xiaoguang LI, Beijing (CN); Jiaqian LI, Beijing (CN); Chen ZHAO, Beijing (CN); Caole LI, Beijing (CN); Xiaolin HOU, Beijing (CN); Shengwang GAO, Beijing (CN)

(73) Assignee: CHINESE RESEARCH ACADEMY OF ENVIRONMENTAL SCIENCES, Beijing (CN)

(21) Appl. No.: 18/009,335

(22) PCT Filed: Oct. 28, 2022
(86) PCT No.: PCT/CN2022/128289

§ 371 Date: Dec. 9, 2022

(30) Foreign Application Priority Data
Dec. 31, 2021 (CN) 202111664181.4

(51) Int. Cl. G06Q 10/0639; G06Q 40/12

(52) U.S. Cl. CPC G06Q 10/0639; G06Q 40/123

(57) ABSTRACT

A water-pollution environmental-protection verification method based on power grid and tax data fusion includes: acquiring power data and tax data corresponding to a plurality of enterprise identities in a target region; acquiring a pollutant output and a sewage purification consumable consumption corresponding to each enterprise identity based on the tax data; determining a first candidate enterprise identity set based on the pollutant output; determining a second candidate enterprise identity set based on the sewage purification consumable consumption and a sewage purification consumable consumption of an actual unit yield of each enterprise identity; acquiring production information of the plurality of enterprise identities based on the power data, and determining a third candidate enterprise identity set; and processing based on the first candidate enterprise identity set, the second candidate enterprise identity set and the third candidate enterprise identity set to determine a target enterprise identity.

### CROSS REFERENCE TO THE RELATED APPLICATIONS

This application is the national phase entry of International Application No. PCT/CN2022/128289, filed on Oct. 28, 2022, which is based upon and claims priority to Chinese Patent Application No. 202111664181.4, filed on Dec. 31, 2021, the entire contents of which are incorporated herein by reference.

### TECHNICAL FIELD

The present disclosure relates to the technical field of environmental monitoring, in particular to a water-pollution environmental-protection verification method and apparatus based on power grid and tax data fusion.

### BACKGROUND

With the continuous improvement pollution prevention and control, environmental-protection requirements for water pollution are also constantly improving.

In the related art, environmental-protection supervision needs a large number of personnel to conduct on-site supervision, which has high human capital, and can't achieve real-time monitoring, and cannot achieve accurate pollution control.

### SUMMARY

In order to solve the foregoing technical problems, the present disclosure provides a water-pollution environmental-protection verification method and apparatus based on power grid and tax data fusion.

The present disclosure provides a water-pollution environmental-protection verification method based on power grid and tax data fusion, including:
acquiring power data and tax data corresponding to a plurality of enterprise identities in a target region;
acquiring a pollutant output and a sewage purification consumable consumption corresponding to each enterprise identity based on the tax data;
determining a first candidate enterprise identity set from the plurality of enterprise identities based on the pollutant output;
determining a second candidate enterprise identity set from the plurality of enterprise identities based on the sewage purification consumable consumption and a sewage purification consumable consumption of an actual unit yield of each enterprise identity;
acquiring production information of the plurality of enterprise identities based on the power data;
determining a third candidate enterprise identity set from the plurality of enterprise identities based on the production information; and
processing based on the first candidate enterprise identity set, the second candidate enterprise identity set and the third candidate enterprise identity set to determine a target enterprise identity.

In an optional embodiment of the present disclosure, the acquiring the pollutant output corresponding to the plurality of enterprise identities based on the tax data, includes:
acquiring material consumable information of the plurality of enterprise identities based on the tax data;
calculating the consumable consumption based on the material consumable information;
determining a total production yield based on the consumable consumption; and
determining the pollutant output based on a pollutant emission factor and the total production yield.

In an optional embodiment of the present disclosure, the acquiring the sewage purification consumable consumption corresponding to the plurality of enterprise identities based on the tax data, includes:
acquiring material consumable information of the plurality of enterprise identities based on the tax data; and
acquiring the sewage purification consumable consumption based on the material consumable information.

In an optional embodiment of the present disclosure, the determining the first candidate enterprise identity set from the plurality of enterprise identities based on the pollutant output, includes:
sorting the plurality of enterprise identities based on the pollutant output in a descending order, and acquiring the top N enterprise identities as the first candidate enterprise identity set; wherein, N is a positive integer.

In an optional embodiment of the present disclosure, the determining the second candidate enterprise identity set from the plurality of enterprise identities based on the sewage purification consumable consumption and the sewage purification consumable consumption of the actual unit yield of the enterprise identity, includes:
comparing the sewage purification consumable consumption and the sewage purification consumable consumption of the actual unit yield, and acquiring the enterprise identity with the sewage purification consumable consumption greater than the sewage purification consumable consumption of the actual unit yield as the second candidate enterprise identity set.

In an optional embodiment of the present disclosure, the acquiring the production information of the plurality of enterprise identities based on the power data, includes:
acquiring an average power consumption per unit time, a variance and a real-time power consumption corresponding to each enterprise identity based on the power data.

In an optional embodiment of the present disclosure, the determining the third candidate enterprise identity set from the plurality of enterprise identities based on the production information, includes:
comparing and calculating based on the average power consumption per unit time, the variance and the real-time power consumption to determine the third candidate enterprise identity set from the plurality of enterprise identities.

In an optional embodiment of the present disclosure, the water-pollution environmental-protection verification method based on power grid and tax data fusion further includes:
acquiring power consumption corresponding to the plurality of enterprise identities based on the power data;
analyzing based on a product yield and the power consumption corresponding to the plurality of enterprise identities to acquire a regression relationship between the product yield and the power consumption; and
acquiring an actual production power consumption corresponding to the plurality of enterprise identities based on the regression relationship.

In an optional embodiment of the present disclosure, the processing based on the first candidate enterprise identity set, the second candidate enterprise identity set and the third candidate enterprise identity set to determine the target enterprise identity, includes:
counting a number of each candidate enterprise identity based on the first candidate enterprise identity set, the second candidate enterprise identity set and the third candidate enterprise identity set; and
comparing based on the number of each candidate enterprise identity and a preset threshold to acquire the candidate enterprise identity with a number greater than the preset threshold as the target enterprise identity.

The present disclosure provides a water-pollution environmental-protection verification apparatus based on power grid and tax data fusion, including:
a data acquisition module configured for acquiring power data and tax data corresponding to a plurality of enterprise identities in a target region;
a pollutant output acquisition module configured for acquiring a pollutant output corresponding to each enterprise identity based on the tax data;
a sewage purification consumable consumption acquisition module configured for acquiring a sewage purification consumable consumption corresponding to each enterprise identity based on the tax data;
a first determining module configured for determining a first candidate enterprise identity set from the plurality of enterprise identities based on the pollutant output;
a second determining module configured for determining a second candidate enterprise identity set from the plurality of enterprise identities based on the sewage purification consumable consumption and a sewage purification consumable consumption of an actual unit yield of each enterprise identity;
a production information acquisition module configured for acquiring production information of the plurality of enterprise identities based on the power data;
a third determining module configured for determining a third candidate enterprise identity set from the plurality of enterprise identities based on the production information; and
a processing module configured for processing based on the first candidate enterprise identity set, the second candidate enterprise identity set and the third candidate enterprise identity set to determine a target enterprise identity.

The embodiments of the present disclosure further provide an electronic device, wherein the electronic device includes: a processor; and a memory configured for storing an instruction executable by the processor; wherein the processor is configured for reading the executable instruction from the memory, and executing the instruction to implement the water-pollution environmental-protection verification method based on power grid and tax data fusion provided by the embodiments of the present disclosure.

The embodiments of the present disclosure further provide a computer-readable storage medium storing a computer program, wherein the computer program is configured for executing the water-pollution environmental-protection verification method based on power grid and tax data fusion provided by the embodiments of the present disclosure.

Compared with the prior art, the foregoing technical solutions provided by the embodiments of the present disclosure have the following advantages.

The power data and the tax data corresponding to the plurality of enterprise identities in the target region are acquired, the pollutant output and the sewage purification consumable consumption corresponding to each enterprise identity are acquired based on the tax data, the first candidate enterprise identity set is determined from the plurality of enterprise identities based on the pollutant output, the second candidate enterprise identity set is determined from the plurality of enterprise identities based on the sewage purification consumable consumption and the sewage purification consumable consumption of the actual unit yield of each enterprise identity, the production information of the plurality of enterprise identities is acquired based on the power data, the third candidate enterprise identity set is determined from the plurality of enterprise identities based on the production information, and processing is performed based on the first candidate enterprise identity set, the second candidate enterprise identity set and the third candidate enterprise identity set to determine the target enterprise identity. In this way, target enterprises of water pollution are identified by fusing power data and tax data, which enriches an environmental-protection management mode, realizes timely warning and tracing of water pollution, further improves an accuracy of pollution control, and realizes dynamic real-time supervision on atmospheric pollution emissions of enterprises.

It is to be understood that the foregoing general description and the following detailed description are exemplary and explanatory only, and cannot limit the present disclosure.

### BRIEF DESCRIPTION OF THE DRAWINGS

The accompanying drawings herein are incorporated into the specification and constitute a part of the specification, show the embodiments consistent with the present disclosure, and serve to explain the principles of the present disclosure together with the specification.

In order to illustrate the technical solutions in the embodiments of the present disclosure or the prior art more clearly, the drawings to be used in the description of the embodiments or the prior art will be briefly described below. Obviously, those of ordinary skills in the art can also obtain other drawings based on these drawings without going through any creative work.

FIG. 1 is an example flow chart of a water-pollution environmental-protection verification method based on power grid and tax data fusion provided by the embodiments of the present disclosure;

FIG. 2 is an example flow chart of another water-pollution environmental-protection verification method based on power grid and tax data fusion provided by the embodiments of the present disclosure;

FIG. 3 is a schematic structural diagram of a water-pollution environmental-protection verification apparatus based on power grid and tax data fusion provided by the embodiments of the present disclosure; and

FIG. 4 is a schematic structural diagram of an electronic device provided by the embodiments of the present disclosure.

### DETAILED DESCRIPTION OF THE EMBODIMENTS

To make the objects, technical solutions and advantages of the embodiments of the present disclosure clearer, the technical solutions in the embodiments of the present disclosure will be described clearly and completely below. Apparently, the described embodiments are merely some but not all of the embodiments of the present disclosure. Based on the embodiments of the present disclosure, all other embodiments obtained by those of ordinary skills in the art without going through any creative work shall fall within the scope of protection of the present disclosure.

During practical application, the production and business activities of all walks of life are inseparable from power consumption, and power data of enterprises may reflect the production and business activities of the enterprises from the side. Meanwhile, tax data is a direct performance of the production and operation of the enterprises. The interactive fusion of these two types of data to build a data base of environmental-protection supervision can help the environmental-protection supervision, improve an effect of the environmental-protection supervision, and increase an efficiency of the environmental-protection supervision.

In the embodiments of the present disclosure, target enterprises of water pollution are identified by fusing power data and tax data, which enriches an environmental-protection management mode, realizes timely warning and tracing of water pollution, further improves an accuracy of pollution control, and realizes dynamic real-time supervision on atmospheric pollution emissions of enterprises.

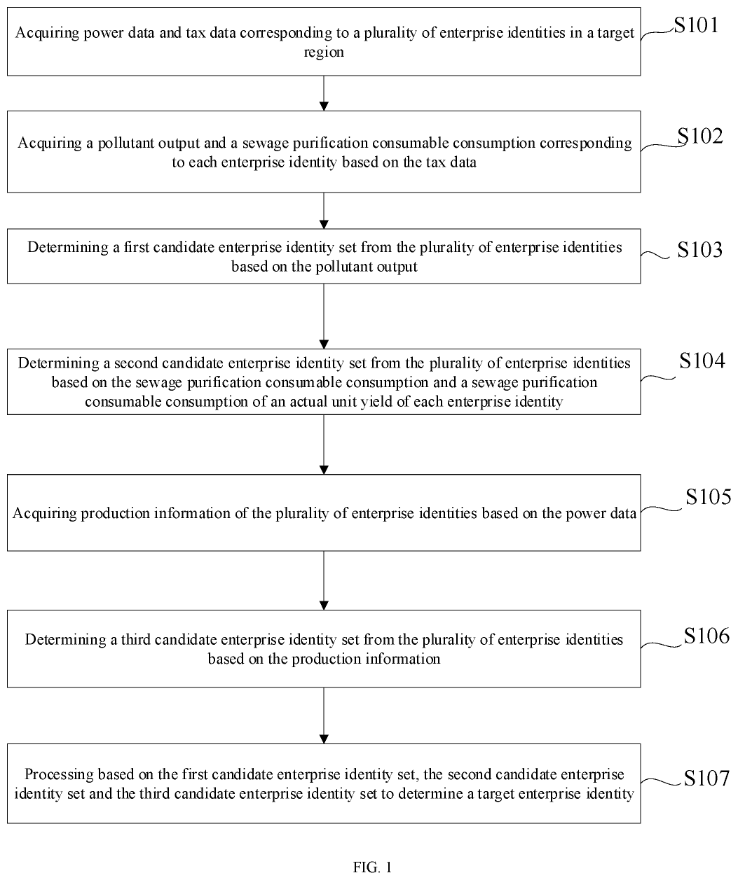

FIG. 1 is an example flow chart of a water-pollution environmental-protection verification method based on power grid and tax data fusion provided by embodiments of the present disclosure. As shown in FIG. 1, the method includes:

Step 101: acquiring power data and tax data corresponding to a plurality of enterprise identities in a target region.

In the embodiment of the present disclosure, the target area may be selected and set according to the needs of application scenes, for example, divided by administrative areas such as a district, a city or a village, or may be divided according to the nature of enterprises such as the target areas corresponding to Enterprises 1 to 10.

It may be understood that the target area includes a plurality of enterprises, and the enterprise identity is used to uniquely identify the enterprise in the target area, for example, a unified social credit code of the enterprise is used as the enterprise identity.

The power data refers to a total power consumption, a power consumption time and other data, and the tax data refers to invoices, tax returns and other data.

Step 102: acquiring a pollutant output and a sewage purification consumable consumption corresponding to each enterprise identity based on the tax data.

In the embodiments of the present disclosure, the pollutant output refers to an amount of pollutants generated by each enterprise, and the sewage purification consumable consumption refers to an amount of sewage purification consumables used by each enterprise.

In some embodiments, material consumable information of the plurality of enterprise identities is acquired based on the tax data, the consumable consumption is calculated based on the material consumable information, a total production yield is determined based on the consumable consumption, and the pollutant output is determined based on a pollutant emission factor and the total production yield.

In some embodiments, the material consumable information of the plurality of enterprise identities is acquired based on the tax data, and the sewage purification consumable consumption is acquired based on the material consumable information.

Step 103: determining a first candidate enterprise identity set from the plurality of enterprise identities based on the pollutant output.

In some embodiments, the plurality of enterprise identities are sorted based on the pollutant output in a descending order, and the top N enterprise identities are acquired as the first candidate enterprise identity set; wherein, N is a positive integer.

In some other embodiments, the actual pollutant output corresponding to each enterprise identity is calculated based on the pollutant output and the weight of each enterprise identity, and the first candidate enterprise identity set is acquired from the plurality of enterprise identities based on the actual pollutant output.

Step 104: determining a second candidate enterprise identity set from the plurality of enterprise identities based on the sewage purification consumable consumption and a sewage purification consumable consumption of an actual unit yield of each enterprise identity.

In the embodiments of the present disclosure, the sewage purification consumable consumption of the actual unit yield of each enterprise identity refers to the sewage purification consumable consumption actually needed by the unit yield of each enterprise.

In some embodiments, the sewage purification consumable consumption is compared with the sewage purification consumable consumption of the actual unit yield to acquire the enterprise identity having the sewage purification consumable consumption greater than the sewage purification consumable consumption of the actual unit yield as the second candidate enterprise identity set.

Step 105: acquiring production information of the plurality of enterprise identities based on the power data.

Step 106: determining a third candidate enterprise identity set from the plurality of enterprise identities based on the production information.

In some embodiments, an average power consumption per unit time, a variance, a real-time power consumption, a total power consumption and other production information corresponding to each enterprise identity may be acquired based on the power data.

In some embodiments, comparing and calculating are performed based on the average power consumption per unit time, the variance and the real-time power consumption to determine the third candidate enterprise identity set from the plurality of enterprise identities.

In some other embodiments, the total power consumption is compared with a preset power quantity threshold to determine the third candidate enterprise identity set from the plurality of enterprise identities.

Step 107: processing based on the first candidate enterprise identity set, the second candidate enterprise identity set and the third candidate enterprise identity set to determine a target enterprise identity.

In some other embodiments, a number of each candidate enterprise identity is counted based on the first candidate enterprise identity set, the second candidate enterprise identity set and the third candidate enterprise identity set, and comparing is performed based on the number of each candidate enterprise identity and a preset threshold to acquire the candidate enterprise identity with a number greater than the preset threshold as the target enterprise identity. The preset threshold may be set by an application scene. In some other embodiments, all the enterprise identities in the first candidate enterprise identity set, the second candidate enterprise identity set and the third candidate enterprise identity set are directly taken as the target enterprise identity.

For example, a plurality of enterprise identities are respectively A, B, C, D, E, F and G, the first candidate enterprise identity set is determined as A, D and F from the plurality of enterprise identities based on the pollutant output, the second candidate enterprise identity set is determined as A, F and G from the plurality of enterprise identities based on the sewage purification consumable consumption and the sewage purification consumable consumption of the actual unit yield of each enterprise identity, and the third candidate enterprise identity set is determined as A, D and E from the plurality of enterprise identities based on the production information, thus counting that a number of the candidate enterprise identity A is 3, a number of the candidate enterprise identity D is two, a number of the candidate enterprise identity E is 1, a number of the candidate enterprise identity F is 2, and a number of the candidate enterprise identity G is 1. For example, the preset threshold is 2, the candidate enterprise identity with the number greater than the preset threshold is acquired as the target enterprise identity, which is the enterprise A.

In conclusion, the water-pollution environmental-protection verification method based on power grid and tax data fusion according to the embodiments of the present disclosure acquires the power data and the tax data corresponding to the plurality of enterprise identities in the target region, acquires the pollutant output and the sewage purification consumable consumption corresponding to each enterprise identity based on the tax data, determines the first candidate enterprise identity set from the plurality of enterprise identities based on the pollutant output, determines the second candidate enterprise identity set from the plurality of enterprise identities based on the sewage purification consumable consumption and the sewage purification consumable consumption of the actual unit yield of each enterprise identity, acquires the production information of the plurality of enterprise identities based on the power data, determines the third candidate enterprise identity set from the plurality of enterprise identities based on the production information, and performs processing based on the first candidate enterprise identity set, the second candidate enterprise identity set and the third candidate enterprise identity set to determine the target enterprise identity. In this way, target enterprises of water pollution are identified by fusing power data and tax data, which enriches an environmental-protection management mode, realizes timely warning and tracing of water pollution, further improves an accuracy of pollution control, and realizes dynamic real-time supervision on atmospheric pollution emissions of enterprises.

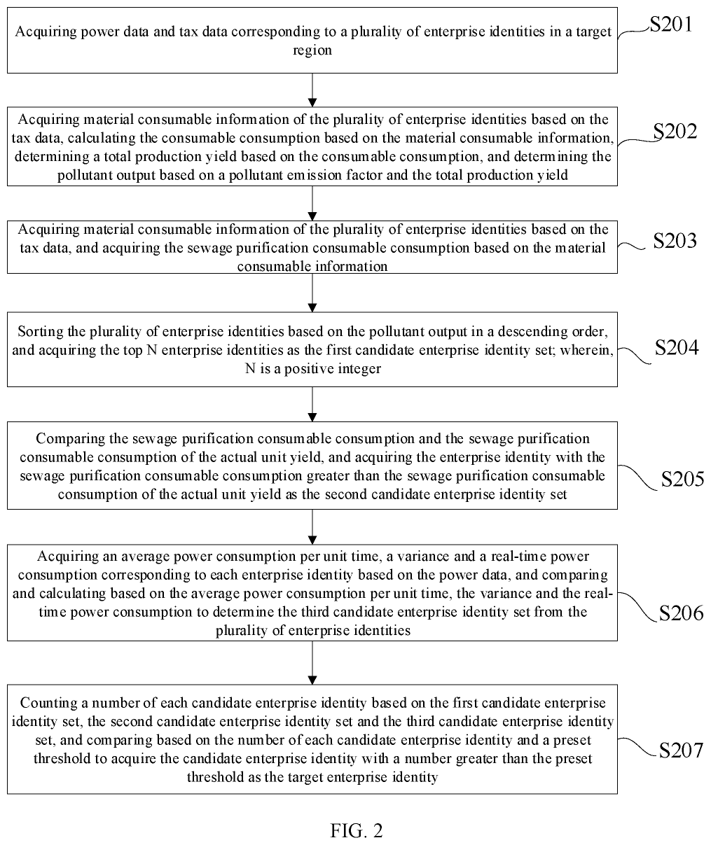

FIG. 2 is an example flow chart of another water-pollution environmental-protection verification method based on power grid and tax data fusion provided by embodiments of the present disclosure. As shown in FIG. 2, the method includes:

Step 201: acquiring power data and tax data corresponding to a plurality of enterprise identities in a target region.

In the embodiment of the present disclosure, the target area may be selected and set according to the needs of application scenes, for example, divided by administrative areas such as a district, a city or a village, or may be divided according to the nature of enterprises such as the target areas corresponding to Enterprises 1 to 10.

It may be understood that the target area includes a plurality of enterprises, and the enterprise identity is used to uniquely identify the enterprise in the target area, for example, a unified social credit code of the enterprise is used as the enterprise identity.

The power data refers to a total power consumption, a power consumption time and other data, and the tax data refers to invoices, tax returns and other data.

Step 202: acquiring material consumable information of the plurality of enterprise identities based on the tax data, calculating the consumable consumption based on the material consumable information, determining a total production yield based on the consumable consumption, and determining the pollutant output based on a pollutant emission factor and the total production yield.

Specifically, the tax data being invoices is taken as an example to explain in detail, and “main commodity name” fields of the invoices are identified by optical character recognition and other technologies to obtain the material consumable of the plurality of enterprise identities, so as to preliminarily judge whether the production and business activities of the enterprises are “water-related”. The consumable consumption may be calculated by using the material consumable information such as “total price”, “unit price”, “unit”, or the like. Furthermore, according to the Law of Conservation of Materials (that is, conservation of elements, a number of atoms of a certain element remains unchanged before and after the change), a corresponding pollutant emission factor (an amount of a certain pollutant discharged per unit output value) is multiplied by the total production yield of the enterprise, and an amount of various pollutants can be calculated.

Step 203: acquiring material consumable information of the plurality of enterprise identities based on the tax data, and acquiring the sewage purification consumable consumption based on the material consumable information.

Specifically, the tax data being invoices is taken as an example to explain in detail, and “main commodity name” fields of the invoices are identified by optical character recognition and other technologies to obtain the material consumable of the plurality of enterprise identities, so as to preliminarily judge whether the enterprises have purified the drainage.

Step 204: sorting the plurality of enterprise identities based on the pollutant output in a descending order, and acquiring the top N enterprise identities as the first candidate enterprise identity set; wherein, N is a positive integer.

Specifically, sorting the enterprise identities according to the pollutant output in a descending order can perform irregular check on the top-ranked enterprise identities to improve supervision targeting.

Step 205: comparing the sewage purification consumable consumption and the sewage purification consumable consumption of the actual unit yield, and acquiring the enterprise identity with the sewage purification consumable consumption greater than the sewage purification consumable consumption of the actual unit yield as the second candidate enterprise identity set.

Specifically, it is possible to judge whether the production of an enterprise has discharged excessive sewage through the sewage purification consumable consumption of the actual unit yield of the enterprise. When the sewage purification consumable consumption of the actual unit yield of the enterprise is less than the sewage purification consumable consumption, it is indicated that the enterprise does not purify the drainage of the enterprise, and the enterprise may be regarded as an important check object.

Step 206: acquiring an average power consumption per unit time, a variance and a real-time power consumption corresponding to each enterprise identity based on the power data, and comparing and calculating based on the average power consumption per unit time, the variance and the real-time power consumption to determine the third candidate enterprise identity set from the plurality of enterprise identities.

Specifically, the power data corresponding to the plurality of enterprise identities, such as historical power consumption data, is acquired, and historical excess pollution discharge days are eliminated to depict monthly and daily power consumption portraits of the normal operation of the enterprise, that is, the monthly and daily average power consumption of the enterprise. As the daily power consumption of the enterprise accords with normal distribution, the average μ and variance σ² of the enterprise may be determined according to the historical power consumption data, and the real-time electricity consumption of the enterprise identity may be judged by using a normal distribution criterion. As long as the real-time power consumption exceeds μ+3σ, it can be judged the enterprise has an abnormal production phenomenon.

In one embodiment of the present disclosure, power consumption corresponding to the plurality of enterprise identities is acquired based on the power data, analyzing is performed based on a product yield and the power consumption corresponding to the plurality of enterprise identities to acquire a regression relationship between the product yield and the power consumption, and an actual production power consumption corresponding to the plurality of enterprise identities is acquired based on the regression relationship.

Specifically, previous researches on a relationship between the power consumption and the pollution emissions of the enterprise did not distinguish between production power consumption and non-production power consumption, which made the calculation of the pollution emissions of the enterprise exceed an actual value, which was not conducive to mastering a real emission situation of the enterprise. Regression analysis may be performed by using the product yield and the power consumption, and y=a+bx, wherein y is the power consumption, x is the product yield, a is a constant term, and b is a coefficient. On one hand, a number relationship between the product yield and the power consumption, i.e., power consumption of a unit product, is acquired; on the other hand, the production power consumption a and the non-production power consumption bx of the enterprise can be distinguished. In this way, the production situation of the enterprise can be better known through the production power consumption of the enterprise, and then the pollution emission situation of the enterprise can be better judged.

Step 207: counting a number of each candidate enterprise identity based on the first candidate enterprise identity set, the second candidate enterprise identity set and the third candidate enterprise identity set, and comparing based on the number of each candidate enterprise identity and a preset threshold to acquire the candidate enterprise identity with a number greater than the preset threshold as the target enterprise identity.

For example, a plurality of enterprise identities are respectively A, B, C, D, E, F and G, the first candidate enterprise identity set is determined as A, D and F from the plurality of enterprise identities based on the pollutant output, the second candidate enterprise identity set is determined as A, F and G from the plurality of enterprise identities based on the sewage purification consumable consumption and the sewage purification consumable consumption of the actual unit yield of each enterprise identity, and the third candidate enterprise identity set is determined as A, D and E from the plurality of enterprise identities based on the production information, thus counting that a number of the candidate enterprise identity A is 3, a number of the candidate enterprise identity D is two, a number of the candidate enterprise identity E is 1, a number of the candidate enterprise identity F is 2, and a number of the candidate enterprise identity G is 1. For example, the preset threshold is 2, the candidate enterprise identity with the number greater than the preset threshold is acquired as the target enterprise identity, which is the enterprise A.

Therefore, linkage between the tax big data and the power big data can be realized, and the sewage discharge of the enterprises can be verified from multiple aspects such as the power consumption and tax revenue of the enterprise, so as to facilitate the identification of enterprises that illegally discharge sewage.

In conclusion, the water-pollution environmental-protection verification method based on power grid and tax data fusion according to the embodiments of the present disclosure acquires the power data and the tax data corresponding to the plurality of enterprise identities in the target region, acquires the material consumable information of the plurality of enterprise identities based on the tax data, calculates the consumable consumption based on the material consumable information, determines the total production yield based on the consumable consumption, determines the pollutant output based on the pollutant emission factor and the total production yield, acquires the material consumable information of the plurality of enterprise identities based on the tax data, acquires the sewage purification consumable consumption based on the material consumable information, sorts the plurality of enterprise identities in a descending order based on the pollutant output, and acquires the top N enterprise identities as the first candidate enterprise identity set; wherein, N is a positive integer; compares the sewage purification consumable consumption with the sewage purification consumable consumption of the actual unit yield, acquires the enterprise identity with the sewage purification consumable consumption greater than the sewage purification consumable consumption of the actual unit yield as the second candidate enterprise identity set, acquires the average power consumption per unit time, the variance and the real-time power consumption corresponding to each enterprise identity based on the power data, performs comparing and calculating based on the average power consumption per unit time, the variance and the real-time power consumption, determines the third candidate enterprise identity set from the plurality of enterprise identities, counts the number of each candidate enterprise identity based on the first candidate enterprise identity set, the second candidate enterprise identity set and the third candidate enterprise identity set, and performs comparing based on the number of each candidate enterprise identity and the preset threshold to acquire the candidate enterprise identity with the number greater than the preset threshold as the target enterprise identity target enterprise identity.

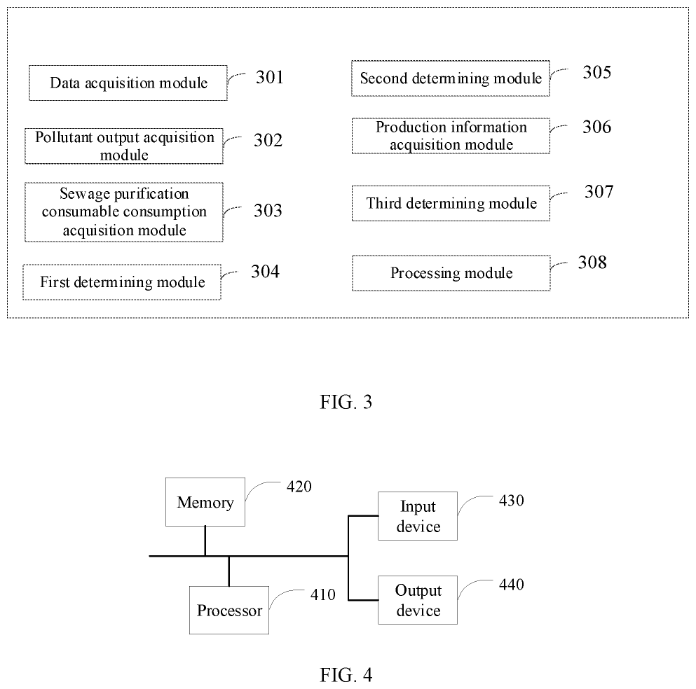

FIG. 3 is a schematic structural diagram of a water-pollution environmental-protection verification apparatus based on power grid and tax data fusion provided by embodiments of the present disclosure. The apparatus includes: a data acquisition module 301, a pollutant output acquisition module 302, a sewage purification consumable consumption acquisition module 303, a first determining module 304, a second determining module 305, a production information acquisition module 306, a third determining module 307 and a processing module 308.

The data acquisition module 301 is configured for acquiring power data and tax data corresponding to a plurality of enterprise identities in a target region.

The pollutant output acquisition module 302 is configured for acquiring a pollutant output corresponding to each enterprise identity based on the tax data.

The sewage purification consumable consumption acquisition module 303 is configured for acquiring a sewage purification consumable consumption corresponding to each enterprise identity based on the tax data.

The first determining module 304 is configured for determining a first candidate enterprise identity set from the plurality of enterprise identities based on the pollutant output.

The second determining module 305 is configured for determining a second candidate enterprise identity set from the plurality of enterprise identities based on the sewage purification consumable consumption and a sewage purification consumable consumption of an actual unit yield of each enterprise identity.

The production information acquisition module 306 is configured for acquiring production information of the plurality of enterprise identities based on the power data.

The third determining module 307 is configured for determining a third candidate enterprise identity set from the plurality of enterprise identities based on the production information.

The processing module 308 is configured for processing based on the first candidate enterprise identity set, the second candidate enterprise identity set and the third candidate enterprise identity set to determine a target enterprise identity.

Optionally, the pollutant output acquisition module 302 is specifically configured for:
acquiring material consumable information of the plurality of enterprise identities based on the tax data;
calculating the consumable consumption based on the material consumable information;
determining a total production yield based on the consumable consumption; and
determining the pollutant output based on a pollutant emission factor and the total production yield.

Optionally, the sewage purification consumable consumption acquisition module 303 is specifically configured for:
acquiring material consumable information of the plurality of enterprise identities based on the tax data; and
acquiring the sewage purification consumable consumption based on the material consumable information.

Optionally, the first determination module 304 is specifically configured for:
sorting the plurality of enterprise identities based on the pollutant output in a descending order, and acquiring the top N enterprise identities as the first candidate enterprise identity set;
wherein, N is a positive integer.

Optionally, the second determining module 305 is specifically configured for:
comparing the sewage purification consumable consumption and the sewage purification consumable consumption of the actual unit yield, and acquiring the enterprise identity with the sewage purification consumable consumption greater than the sewage purification consumable consumption of the actual unit yield as the second candidate enterprise identity set.

Optionally, the production information acquisition module 306 may be specifically configured for:
acquiring an average power consumption per unit time, a variance and a real-time power consumption corresponding to each enterprise identity based on the power data.

Optionally, the third determining module 307 is specifically configured for:
comparing and calculating based on the average power consumption per unit time, the variance and the real-time power consumption to determine the third candidate enterprise identity set from the plurality of enterprise identities.

Optionally, the device further includes:
a power consumption acquisition module configured for acquiring a power consumption corresponding to the plurality of enterprise identities based on the power data;
an analysis module configured for analyzing based on a product yield and the power consumption corresponding to the plurality of enterprise identities to acquire a regression relationship between the product yield and the power consumption; and
an acquisition module configured for acquiring an actual production power consumption corresponding to the plurality of enterprise identities based on the regression relationship.

Optionally, the processing module 308 is specifically configured for:
counting a number of each candidate enterprise identity based on the first candidate enterprise identity set, the second candidate enterprise identity set and the third candidate enterprise identity set; and
comparing based on the number of each candidate enterprise identity and a preset threshold to acquire the candidate enterprise identity with a number greater than the preset threshold as the target enterprise identity.

In conclusion, the water-pollution environmental-protection verification method based on power grid and tax data fusion according to the embodiments of the present disclosure acquires the power data and the tax data corresponding to the plurality of enterprise identities in the target region, acquires the pollutant output and the sewage purification consumable consumption corresponding to each enterprise identity based on the tax data, determines the first candidate enterprise identity set from the plurality of enterprise identities based on the pollutant output, determines the second candidate enterprise identity set from the plurality of enterprise identities based on the sewage purification consumable consumption and the sewage purification consumable consumption of the actual unit yield of each enterprise identity, acquires the production information of the plurality of enterprise identities based on the power data, determines the third candidate enterprise identity set from the plurality of enterprise identities based on the production information, and performs processing based on the first candidate enterprise identity set, the second candidate enterprise identity set and the third candidate enterprise identity set to determine the target enterprise identity. In this way, target enterprises of water pollution are identified by fusing power data and tax data, which enriches an environmental-protection management mode, realizes timely warning and tracing of water pollution, further improves an accuracy of pollution control, and realizes dynamic real-time supervision on atmospheric pollution emissions of enterprises.

The water-pollution environmental-protection verification apparatus based on power grid and tax data fusion provided by the embodiments of the present disclosure can execute the water-pollution environmental-protection verification method based on power grid and tax data fusion provided by any embodiment of the present disclosure, and has the corresponding functional modules and beneficial effects of executing the method.

FIG. 4 is a schematic structural diagram of an electronic device provided by the embodiments of the present disclosure. As shown in FIG. 4, the electronic device includes a processor 410, a memory 420, an input device 430 and an output device 440. The number of the processor 410 in the electronic device may be one or more, and one processor 410 is taken as an example in FIG. 4. The processor 410, the memory 420, the input device 430, and the output device 440 in the electronic device may be connected via a bus or otherwise. Bus connection is taken as an example in FIG. 4.

As a computer-readable storage medium, the memory 420 may be used to store software programs, computer executable programs and modules, such as program instructions/modules corresponding to the water-pollution environmental-protection verification method based on power grid and tax data fusion in the embodiments of the present disclosure. The processor 410 runs the software programs, instructions, and modules stored in the memory 420, thus performing various functional applications and data processing of the electronic device, that is, implementing the water-pollution environmental-protection verification method based on power grid and tax data fusion provided by the embodiments of the present disclosure.

The memory 420 may mainly include a program storage area and a data storage area, wherein the program storage area may store application programs required by an operating system and at least one function. The data storage area may store data and the like created according to the use of the terminal. In addition, the memory 420 may include a high-speed random access memory, and may also include a non-volatile memory, such as at least one disk memory device, a flash memory device, or other non-volatile solid storage devices. In some examples, the memory 420 may further include memories remotely disposed with respect to the processor 410, and these remote memories may be connected to the electronic device through networks. Examples of the networks above include, but are not limited to, the Internet, intranet, local area networks, mobile communication networks, and combinations thereof.

The input device 430 may be configured to receive input numeric or character information, and generate key signal input related to user setting and function control of the electronic device, and may include a keyboard, a mouse, and the like. The output device 440 may include a display screen and other display devices.

The embodiments of the present disclosure further provide a storage medium containing a computer-executable instruction, wherein the computer-executable instruction, when executed by a computer processor, is configured for executing the water-pollution environmental-protection verification method based on power grid and tax data fusion provided by the embodiments of the present disclosure.

Certainly, as for the storage medium containing the computer-executable instruction provided by the embodiments of the present disclosure, the computer-executable instruction is not limited to the above method operations, and may also perform related operations in the water-pollution environmental-protection verification method based on power grid and tax data fusion provided by an embodiment of the present disclosure.

Through the description of the above embodiments, those skilled in the art can clearly understand that the present disclosure can be implemented by means of software plus necessary general hardware, and certainly, can be implemented by means of hardware, but in many cases, the former is a better implementation manner. Based on such understanding, the technical solutions of the present disclosure in essence or the part contributed to the related art may be embodied in the form of a software product which is stored in a computer-readable storage medium such as a floppy disc of a computer, a Read-Only Memory (ROM), a Random Access Memory (RAM), a flash (FLASH), a hard disk, or an optical disk which include a plurality of instructions such that one computer device (which may be a personal computer, a server, or a network device, etc.) performs the methods described in each of the embodiments of the present disclosure.

It is noteworthy that in the embodiments of the above-mentioned verification apparatus, various units and modules included are only divided according to functional logics, but are not limited to the above-mentioned division, as long as the corresponding functions can be realized. In addition, the specific names of each functional unit are only for convenience of distinguishing from each other, and are not used to limit the scope of protection of the present disclosure.

It should be noted that relational terms herein such as “first” and “second” and the like, are used merely to distinguish one entity or operation from another entity or operation, and do not necessarily require or imply there is any such relationship or order between these entities or operations. Furthermore, the terms “including”, “comprising” or any variations thereof are intended to embrace a non-exclusive inclusion, such that a process, method, article, or device including a plurality of elements includes not only those elements but also includes other elements not expressly listed, or also incudes elements inherent to such a process, method, article, or device. In the absence of further limitation, an element defined by the phrase “including a . . . ” does not exclude the presence of additional identical element in the process, method, article, or device.

The above are only specific embodiments of the present disclosure, so that those skilled in the art can understand or realize the present disclosure. Many modifications to these embodiments will be obvious to those skilled in the art, and the general principles defined herein can be implemented in other embodiments without departing from the spirit or scope of the present disclosure. Therefore, the present disclosure will not to be limited to these embodiments shown herein, but is to be in conformity with the widest scope consistent with the principles and novel features disclosed herein.

What is claimed is:

1. A water-pollution environmental-protection verification method based on power grid and tax data fusion, comprising:
acquiring power data and tax data corresponding to a plurality of enterprise identities in a target region;
acquiring a pollutant output and a sewage purification consumable consumption corresponding to each enterprise identity of the plurality of enterprise identities based on the tax data;
determining a first candidate enterprise identity set from the plurality of enterprise identities based on the pollutant output;
determining a second candidate enterprise identity set from the plurality of enterprise identities based on the sewage purification consumable consumption corresponding to each enterprise identity and a sewage purification consumable consumption of an actual unit yield of each enterprise identity;
acquiring production information of the plurality of enterprise identities based on the power data;
determining a third candidate enterprise identity set from the plurality of enterprise identities based on the production information; and
processing based on the first candidate enterprise identity set, the second candidate enterprise identity set and the third candidate enterprise identity set to determine a target enterprise identity.

2. The water-pollution environmental-protection verification method based on the power grid and tax data fusion according to claim 1, wherein the step of acquiring pollutant output corresponding to the plurality of enterprise identities based on the tax data, comprises:
acquiring material consumable information of the plurality of enterprise identities based on the tax data;
calculating consumable consumption based on the material consumable information;
determining a total production yield based on the consumable consumption; and
determining the pollutant output based on a pollutant emission factor and the total production yield.

3. The water-pollution environmental-protection verification method based on the power grid and tax data fusion according to claim 1, wherein the step of acquiring sewage purification consumable consumption corresponding to the plurality of enterprise identities based on the tax data, comprises:
acquiring material consumable information of the plurality of enterprise identities based on the tax data; and
acquiring the sewage purification consumable consumption corresponding to the plurality of enterprise identities based on the material consumable information.

4. The water-pollution environmental-protection verification method based on the power grid and tax data fusion according to claim 1, wherein the step of determining the first candidate enterprise identity set from the plurality of enterprise identities based on the pollutant output, comprises:
sorting the plurality of enterprise identities based on the pollutant output in a descending order, and acquiring top N enterprise identities as the first candidate enterprise identity set; wherein N is a positive integer.

5. The water-pollution environmental-protection verification method based on the power grid and tax data fusion according to claim 1, wherein the step of determining the second candidate enterprise identity set from the plurality of enterprise identities based on the sewage purification consumable consumption corresponding to each enterprise identity and the sewage purification consumable consumption of the actual unit yield of each enterprise identity, comprises:
comparing the sewage purification consumable consumption corresponding to each enterprise identity and the sewage purification consumable consumption of the actual unit yield of each enterprise identity, and acquiring the enterprise identity with the sewage purification consumable consumption greater than the sewage purification consumable consumption of the actual unit yield as the second candidate enterprise identity set.

6. The water-pollution environmental-protection verification method based on the power grid and tax data fusion according to claim 1, wherein the step of acquiring the production information of the plurality of enterprise identities based on the power data, comprises:
acquiring an average power consumption per unit time, a variance and a real-time power consumption corresponding to each enterprise identity based on the power data.

7. The water-pollution environmental-protection verification method based on the power grid and tax data fusion according to claim 6, wherein the step of determining the third candidate enterprise identity set from the plurality of enterprise identities based on the production information, comprises:
comparing and calculating based on the average power consumption per unit time, the variance and the real-time power consumption to determine the third candidate enterprise identity set from the plurality of enterprise identities.

8. The water-pollution environmental-protection verification method based on the power grid and tax data fusion according to claim 1, further comprising:
acquiring power consumption corresponding to the plurality of enterprise identities based on the power data;
analyzing based on a product yield and the power consumption corresponding to the plurality of enterprise identities to acquire a regression relationship between the product yield and the power consumption; and
acquiring an actual production power consumption corresponding to the plurality of enterprise identities based on the regression relationship.

9. The water-pollution environmental-protection verification method based on the power grid and tax data fusion according to claim 1, wherein the step of processing based on the first candidate enterprise identity set, the second candidate enterprise identity set and the third candidate enterprise identity set to determine the target enterprise identity, comprises:
counting a number of each candidate enterprise identity based on the first candidate enterprise identity set, the second candidate enterprise identity set and the third candidate enterprise identity set; and
comparing based on the number of each candidate enterprise identity and a preset threshold to acquire a candidate enterprise identity with a number greater than the preset threshold as the target enterprise identity.

10. A water-pollution environmental-protection verification apparatus based on power grid and tax data fusion, comprising:
a data acquisition module configured for acquiring power data and tax data corresponding to a plurality of enterprise identities in a target region;
a pollutant output acquisition module configured for acquiring a pollutant output corresponding to each enterprise identity of the plurality of enterprise identities based on the tax data;
a sewage purification consumable consumption acquisition module configured for acquiring a sewage purification consumable consumption corresponding to each enterprise identity based on the tax data;
a first determining module configured for determining a first candidate enterprise identity set from the plurality of enterprise identities based on the pollutant output;
a second determining module configured for determining a second candidate enterprise identity set from the plurality of enterprise identities based on the sewage purification consumable consumption corresponding to each enterprise identity and a sewage purification consumable consumption of an actual unit yield of each enterprise identity;
a production information acquisition module configured for acquiring production information of the plurality of enterprise identities based on the power data;
a third determining module configured for determining a third candidate enterprise identity set from the plurality of enterprise identities based on the production information; and
a processing module configured for processing based on the first candidate enterprise identity set, the second candidate enterprise identity set and the third candidate enterprise identity set to determine a target enterprise identity.
